(19) United States
(12) Patent Application Publication
(10) Pub. No.: US 2013/0002201 A1
(43) Pub. Date: Jan. 3, 2013

(54) SYSTEM AND METHOD OF INTEGRATED BATTERY CHARGING AND BALANCING

(75) Inventors: Richard Bodkin, Tucson, AZ (US); Richard Lukso, Tucson, AZ (US)

(73) Assignee: PANACIS INC., OTTAWA, ON (CA)

(21) Appl. No.: 13/512,744

(22) PCT Filed: Dec. 8, 2010
(86) PCT No.: PCT/IB10/55654

§ 371 Date: May 30, 2012

Related U.S. Application Data
(60) Provisional application No. 61/267,879, filed on Dec. 9, 2009.

(51) Int. Cl. H02J 7/00

(52) U.S. Cl. 320/118

(57) ABSTRACT

A system and method is provided that allows the cells making up a battery pack to be kept at equal energy storage levels through the use of active re-distribution of the energy in each cell through a bi-directional transformer coupling means that will allow balancing to occur during charging, discharging, bulk charging, parallel charging or idle states.

### TECHNICAL FIELD

This invention pertains to the field of batteries, and particularly to the methods used to maintain and control the individual cells that make up a battery by the application of charging, charge balancing and discharge balancing energy.

### BACKGROUND ART

It is well understood that modern battery technologies have significant safety issues related to the energy stored within them. Many modern technologies such as lithium based chemistries, are very sensitive to overcharging or over discharging. It is therefore desirable to implement a system that maintains each cell in a given battery pack at the same state of charge. As the cells in a battery pack wear out, their capacities tend to drift apart.

Conventional balancing technologies focus only on the individual cell voltages at the end of charging. A number of active and passive cell balancing techniques have been proposed that ensure each cell in a battery pack ends up fully charged at about the same voltage, usually within 1% of each other. This type of cell balancing, often called charge-balancing, only ensures the cell voltages match, it does not actually improve the capacity of the weakest cell, as such, if one cell in the battery pack has only 80% nominal capacity compared to the other cells in the pack, then the entire battery will appear to be operating at only 80% capacity since it is that weakest cell that will cause battery output premature cutoff.

U.S. Pat. No. 6,586,909 issued to Trepka teaches a Parallel Battery Charging Device. This device uses a single transformer core with a primary winding and multiple secondary windings. Each secondary winding is connected to a voltage regulator circuit and the regulated voltage is then applied to each cell in the battery pack. It can be appreciated that when this charger is turned on, energy is applied to the primary and transferred to the secondary winding whereby it is applied to the cells such that each cell in the battery pack will achieve full charge at a voltage which is pre-set by the regulator. It can be appreciated that the need for additional regulators on each cell adds to the complexity of the system considerably. Trepka also teaches that a single diode could also be used instead of a regulator, further demonstrating that this system was only intended as a one-way charging system intended to act effectively like a group of individual chargers, each connected to an individual cell. Indeed, there would be no difference in terms of the battery pack operation if multiple separate chargers were purchased and each connected to a cell in the pack. There is a further disadvantage to using a diode when applied to advanced cell technologies that require better than 1% charging accuracy. The voltage drop of a diode is typically several hundred milli-volts and varies with the amount of current flow. Therefore, it is not possible to match the cell voltages adequately with diodes and conventional wire-wound transformers as shown.

A further disadvantage of a parallel charging system is the power limitations of the magnetic transformer used. Trepka illustrates a single transformer core with multiple windings. Therefore the maximum amount of energy that can be delivered to the entire battery pack will be limited by the parameters of the core with respect to energy storage. For very high charge rates, this core may become larger and heavier than the battery itself.

There remains a need for a parallel charging system that allows for cell voltages to be accurately matched during charging without the need for additional regulator systems and for battery charging to occur at high rates without large increases in size, weight or excessive internal power losses.

Conventional passive cell balancing systems use resistors or other components to control charge current and dissipate energy from cells that have higher than normal voltages during charging. There are hundreds of patents with respect to the means and algorithms used in applying these balancing technologies. It is acknowledged that for small capacity systems with only a few cells, these systems can provide adequate cell balancing, generally in the 100 mA range or less. However, for large capacity batteries the amount of energy required to maintain the cells in balance is very high and creates major thermal management issues. Therefore, the use of passive balancing technologies is generally discouraged in larger packs.

Passive cell balancing is also used, generally, during charging only. As energy is applied to the battery pack, individual cells that have higher than expected voltages will dissipate extra energy through the balancing circuit. If these circuits were used during discharge, then they would effectively reduce the capacity of the battery pack because there is no energy replenishment of the weaker cells. In either situation, passive balancing does not improve the overall capacity of the battery pack beyond the capacity of the weakest cell.

Active cell balancing allows energy to be drawn from one cell and returned to another cell. Numerous patents exist for systems and methods of cell balancing. These systems rely on capacitive or inductive energy storing devices which alternately collect energy from stronger cells and delivers it to weaker cells. Most active cell balancing systems utilize single inductors or transformers on each cell and can therefore shuttle energy from one cell to the nearest neighbor. These systems have the advantage of being used in both charging and discharging and because they are actually moving energy around inside the battery pack, they can effectively increase the capacity of the battery pack beyond the capacity of the weakest cell. Active cell balancing is typically done at a rate that is a fraction of the total capacity of the battery pack, often at around 1.0 amp or less. This allows minor differences in cell capacity to be adjusted to keep the cells safe. Therefore, a battery pack with a single cell that was slightly weaker than other cells, may be effectively balanced during charge or discharge. However, at higher current and higher imbalance levels, these systems may not suffice as they only have the ability to transfer energy between two cells.

There remains a need for an active cell balancing system that can transfer significant energy from multiple cells to one cell, or vice-versa during discharge as well as during charge.

### DISCLOSURE OF INVENTION

### Technical Problem

### Technical Solution

In order to overcome the deficiencies noted above, we propose as a solution our invention, namely, an integrated battery charging and cell balancing system. In one embodiment of the invention the system is composed of a voltage regulated power converter driving a transformer core with a primary winding and multiple secondary windings. The primary-to-secondary turns ratio provides the precise voltage needed at the individual cell level. The secondary windings are attached to each cell through a bi-directional switching circuit. The primary is attached to a waveform source and storage element. The battery is further connected to a bulk energy source. The waveform source would gain power from a common point with the bulk energy source. During cell-balance charging the waveform source delivers energy to the primaries and the switching elements act as a synchronous rectifier. The windings of each transformer are matched using systems and methods such as those shown in our patent application PCT/IB2010/053442 Method and Apparatus of Signal Conversion filed on Jul. 29, 2010 and herein incorporated by reference. Each cell can therefore charge to a voltage that is the same as every other cell. For more rapid charging, the bulk method of charging may be employed where energy is allowed to flow into the series string of cells directly. Cell balancing can remain active during bulk charging, thereby providing the most rapid overall charging rates.

The synchronous switching element can also allow energy to flow out of the cells as well as into the cells. This can be controlled on a cell-by-cell basis and will allow energy from any given cell to be captured by the energy storage device on the input to the transformer. This energy can then be applied to a cell that needs it through re-application of the switching element on that cell.

By example, a battery can be constructed using this system and method that would allow 10 amps of cell balancing current during charging and would allow an additional 100 amps of charging via the bulk-mode transistor. Additionally, 10 amps of cell balancing current would be available during discharge to improve the capacity of the battery pack under real load conditions, in this case for load of 10 amps or less, the balancing circuit could accommodate any cell variation, even if one cell only possessed 1% of normal capacity.

In another embodiment of the invention, the battery may possess multiple transformer cores. For example, a single transformer core may have one primary and two secondary windings and would therefore be capable of working with two cells. Connection of the primary windings would therefore be equivalent to a single core transformer.

### ADVANTAGEOUS EFFECTS

### Description of Drawings

FIG. 1 shows typical passive cell balancing system.

FIG. 2 shows typical parallel charging.

FIG. 3 shows typical inductive cell balancing.

FIG. 4 shows the preferred embodiment of the invention using a single transformer.

FIG. 5 shows the preferred embodiment of the invention having a controller.

FIG. 6 shows an example of the energy transfer paths of the preferred embodiment.

### BEST MODE

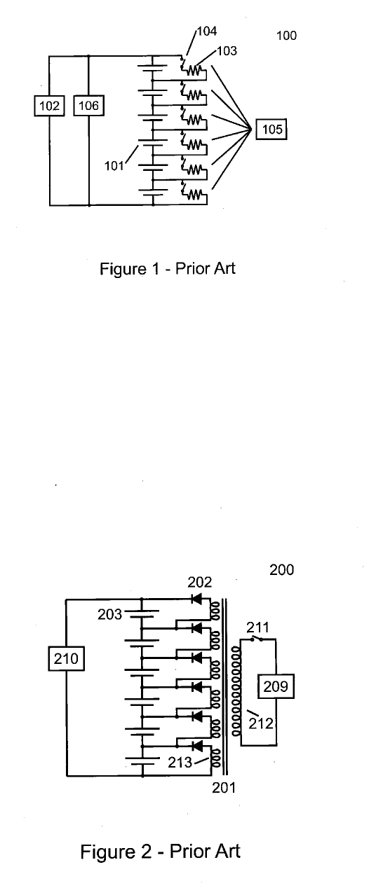

Referring to FIG. 1, there is shown a typical passive cell balancing system (100). A series string of cells (101) is connected to an energy source (102) which supplies charging energy to the system. Each cell has an individual passive element (103) which is engaged by switch closure (104) controlled by a battery control circuit (105), also called a battery management system. A load (106) is also shown connected to the series string of cells. The passive elements will dissipate extra energy in the form of heat to reduce the charging rate of the cells with the highest voltage. The battery control circuit (105) therefore engages the appropriate passive element (103) based on the chosen cell balancing algorithm.

FIG. 2 shows a typical parallel charging system (200) that utilizes a single transformer element (201) to deliver energy through a diode or regulator (202) to each individual cell (203). The energy source (209) transfers energy into the transformer element (201) through a switching element (211) which provides the alternating magnetic field required to allow energy to pass from the primary windings (212) of the transformer to the secondary windings (213) and which is then divided between the cells. The cell with the lowest voltage will gain a higher amount of energy from the transformer. A load (210) is connected to the series string of cells.

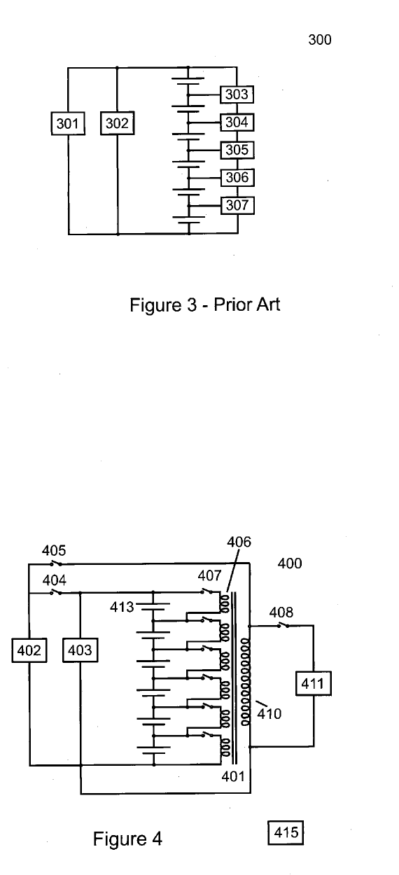

FIG. 3 shows a typical active cell balancing system (300). The energy source for charging (301) is connected to the series string of cells as is the load (302). Each pair of cells then shares an energy transfer element (303, 304, 305, 306, 307). The number of transfer elements will be one less than the number of cells. Each transfer element can accept energy from one cell and transfer it to the other cell. In this way, energy may be passed from cell to cell to cell to cell in serial fashion with associated efficiency losses that would occur. This system can be employed during charging or discharging, but the overall ability of the system to effectively transfer energy into the weakest cell will diminish as the number of cells increases due to the need to pass energy from cell to cell.

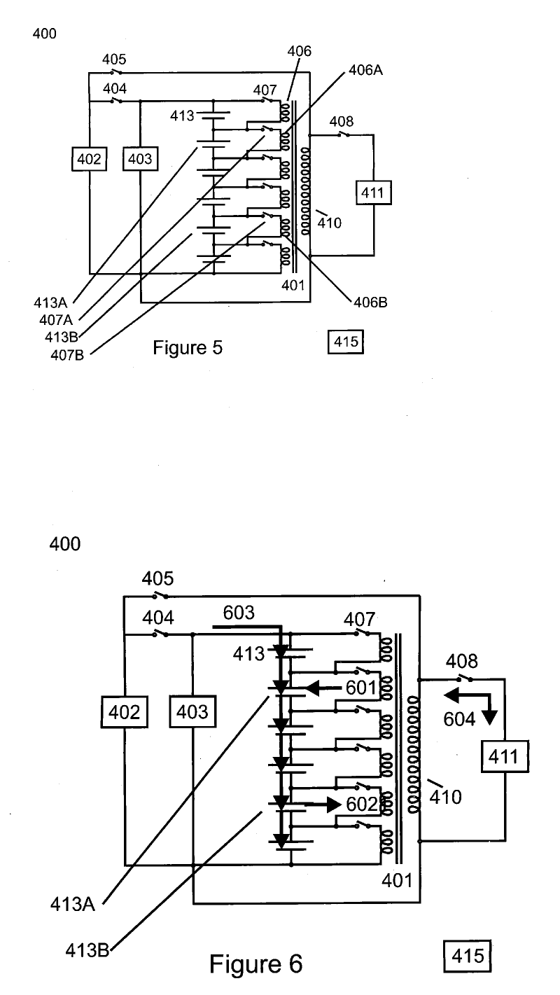

FIG. 4 and FIG. 5 show the preferred embodiment of the invention (400) using one transformer (401) with a charger (402) connected to the series string of cells through a bulk charge control switch (404) and a load (403) connected to the series string of cells. The charger is also connected to the transformer primary (410) through a waveform switching element (405) which provides the alternating magnetic field required to allow energy to pass from the primary winding (410) of the transformer to the secondary windings (406) and which is then passed only to the cells which require it through the cell-switch elements (407) associated with each secondary winding. Controller 415 is illustrated and would have logical connections to the various components of the system. These are not shown as they would be understood by a skilled person. Controller 415 would be connected through appropriate circuitry to sense every cell energy level via voltage, current or other means. Controller 415 would connect to every switch or to analog or digital circuitry controlling every switch shown in the system. Controller 415 may also include communication elements for communication with the load system (403) for communication of state of charge or other battery parameters. It may communicate with the charger (402) and with the operator (not shown) through any number of user interfaces including lights, displays, audio and tactile controls.

Illustrated in FIG. 5, for explanatory purposes, is a low-energy cell 413A and a high-energy cell 413B. Low-energy cell 413A has an adjacent bi-directional switch 407A to connect it to the adjacent secondary coil 406A. Similarly, high-energy cell 413B is connected by bi-directional switch 407B to adjacent secondary coil 406B.

It should be noted that the term switch is use in the sense of any electrical control element that can include multi-pole, waveform generating, synchronous and chopping elements designed to facilitate the transfer of energy as appropriate to the goals of the circuit design, power levels, voltages and efficiency levels sought.

In addition, an energy storage element (411) such as a capacitor, is connected to the primary winding (410) through an additional balancing-charge switching element (408) which can act as a synchronous rectifier to deliver energy from the transformer into the energy storage element (411). The additional balancing-charge switching element (408) can also serve as a waveform generator which provides the alternating magnetic field required to allow energy to pass from the primary winding (410) of the transformer to the secondary windings (406).

Further illustrated in FIG. 6 is an example of the energy transfer paths that would exist when bulk charging is enabled as well as charge balancing from one cell to another cell. The charge balancing takes energy (602) from the highest energy cell (413B) and transfers it (604) to the energy storage element (411). The energy may be transferred (601) into the lowest energy cell (413A) directly through the transformer (401) or by extracting the energy (604) from the energy storage element (411). In addition, energy may be transferred (603) from the charger (402) into all of the cells of the system. This ability to supply energy into all the cells while simultaneously taking energy from one or more high-energy cells and transfer it to one or more low energy cells is a key aspect of the invention and is only one example of the plurality of operating modes such bi-directional energy transfer from the individual cells will enable.

It is important to note that the transformer in this case would generally have a turns-ratio of about X:1 where X is the number of cells in the battery system. This allows the overall pack voltage which is XV where V is the average voltage of the individual cells to be divided into a voltage V which matches the individual cells. It is also possible to construct the transformer with separate primary windings in order to facilitate or simplify the actual construction of the circuitry involved such that the act of balancing and the act of charging could be carried out by application of energy to two different primary windings and combined by a single core into the secondaries, or by two completely separate transformers with separate primaries, separate cores and separate secondaries, while still carrying out the functions and energy transfer paths as described herein.

There are five modes of operation used in this system:

Discharge Mode: The load is connected to the battery, all other switching elements are off. Power is delivered to the load (if the load is present) or the battery is idle if no load is present. This is the normal mode used for supplying energy to a load.

Discharge Balancing Mode: The load is connected to the battery (if a load is not present, then the battery will be idle). Simultaneously, if the battery control circuitry (not shown) detects that cell balancing is required, then the cell switch elements (407) associated with the highest energy cells would delivery energy through the secondary windings (406) through the transformer core through the balancing-charge switch element (408) into the energy storage element (411). The battery control circuitry would then identify the cells which have the least amount of energy and the balancing-charge switch element (408) would deliver energy from the energy storage element (411) through the transformer core to the secondary windings (406) and through the cell switch elements (407) to the cells that require extra energy.

In this way, energy is being efficiently transferred from the highest energy cells in the pack to the weakest, even if the pack is idle or if the pack is under heavy discharge. It is also a key advantage of this invention that any number of cells can simultaneously deliver energy to any other number of cells.

Bulk Charging Mode: This mode allows energy to be transferred from a charger to the battery system. The bulk charge control switch (404) will connect the charger (402) to the battery string and this will allow charging at whatever rate the switch and charger can handle, even at a rate of hundreds or thousands of amps. When charging is complete the bulk charge control switch (404) can be opened by the battery control circuitry or charging may be terminated by the charger itself in ways that are well understood in the art. The bulk charge control switch (404) may also be composed of a current control element that has the ability to limit the amount of current flowing into the battery to allow for constant charge current levels.

Balanced Charging Mode: This mode allows energy to be transferred from a charger to the battery system in a way that is balanced and in a way that promotes balancing. The charger (402) is used as an energy source which, through the switches and transformers previously described can transfer energy to all the cells in the pack at the same time. Using matched transformer windings, the charge voltage on each cell can be maintained within the required accuracy range. This mode will typically operate at a rate in the range of 1 to 30 amps, with higher currents possible only with the use of very large magnetic elements, high power switches and high frequencies. Individual cells can also be charged at different rates by varying the current through the switches that connect each cell, such control could be implemented using pulse-width modulation, frequency control, or a number of other well understood methods.

Fast Charging Mode: In this mode, the system attempts to charge the battery pack as quickly as possible by using the Bulk Charging Mode to deliver a lot of current to the battery pack and at the same time the Balanced Charging Mode is engaged. This allows the cells to balance at the same time high charge current is being delivered, with an end result that the battery pack may be completely recharged in a few minutes.

The transformer system can also be configured or broken up into separate units. For example, a six cell battery pack could be fashioned using one transformer core with six secondary windings. Alternatively two cores, each with three secondary windings, or three cores each with two secondary windings could be used.

The system and method of operation of the system can also be described as follows:

The invention teaches a system 400 for integrated battery charging and cell balancing. The system comprises a plurality of serially connected cells 413 forming a battery and a load 403 connected to the battery. The system also comprises a transformer 401 comprising a primary coil 410 and a plurality of secondary coils 406. The number of the plurality of secondary coils 406 is equal to the number of the plurality of serially connected cells 413. Each one of the plurality of secondary coils 406 is electrically connected to a single one of the plurality of serially connected cells 413 by one of a plurality of bi-directional first switches 407. The plurality of bi-directional first switches 407 is equal in number to the plurality of the serially connected cells 413 and secondary coils 406. The system includes a capacitor 411 for energy storage connected to the primary coil 410 by a second switch 408 and a battery charger 402 connected to the plurality of serially connected cells 413 by a third switch 404. In the system there is a fourth switch 405 connecting the battery charger 402 to the primary coil 410 and a controller 415 for controlling the system 400 on a bulk basis and on a cell-by-cell basis so that a surplus of energy in the system is distributed in a balanced manner to and from one of the capacitor 411 and the plurality of serially connected cells 413.

In the plurality of serially connected cells 413 forming the battery there is at least one cell having an low-energy condition 413A and at least one cell having an high-energy condition 413B. The controller 415 is adapted to identify the at least one cell having the low-energy condition 413A and the at least one cell having an high-energy condition 413B.

The second switch 408 is a balancing-charge switch element. In one embodiment of the invention the balancing-charge switch 408 is a synchronous rectifier to deliver the energy surplus from one of the battery charger 402 and/or the plurality of cells 413 into the primary coil 410 and then into the capacitor 411 for energy storage. When the capacitor 411 has the energy surplus the third switch 404 may be open or closed depending on the speed of charge desired and the fourth switch 405 will be open. The plurality of first switches 407 will be closed and the balancing-charge switch 408 will be closed.

In one embodiment of the invention the balancing charging switch 408 is a first waveform generator for generating an alternating magnetic field in the primary coil 410. In turn, this will generate a current in the plurality of secondary coils 406 hence charging and balancing the plurality of serially connected cells 413 through the plurality of first switches 407 until a charged and balanced condition is detected by the controller.

When the capacitor 411 has an energy surplus and when the controller 415 detects at least one cell 413A as being low-energy the third switch 404 may be is open or closed depending on whether the battery is charging or not. The fourth switch 405 is open and the balancing-charge switch 408 is closed. The first switch 407A is closed so that the energy surplus is transferred from the capacitor 411 to the primary coil 410 generating an alternating magnetic field and thus a current into the adjacent secondary coil 406A. The energy will then flow into the at least one cell 413A to increase the energy level of that low-energy cell.

When the fourth switch 405 is open and the second switch 408 is open and the plurality of first switches 407 are open and the third switch 404 being a bulk charge control switch is closed the battery charger 402 will simultaneously charges all cells in the plurality of serially connected cells 413.

In one embodiment of the invention the fourth switch 405 is a second waveform generator for generating the alternating magnetic field in the primary coil 410. Hence, when the second waveform generator 405 is closed and second switch 408 is open the surplus energy is transferred from the battery charger 402 through the second waveform generator 405 to the primary coil 410. This will generate an alternating magnetic field in the primary coil and hence a current in the plurality of secondary coils 406 for charging and balancing the plurality of serially connected cells 413 through closed first switches 407.

When the system has at least one high-energy cell 413B having an energy surplus and at least one low-energy cell 413A having an energy deficit the system can be balanced by opening second switch 408, the third switch 404, the fourth switch 405 and switches 407. The controller then closes the first switch 407B adjacent to the at least one high-energy cell 413B and closes the first switch 407A adjacent to the at least one low-energy cell 413A so that the energy surplus is transferred from cell 413B through secondary coil 406B to the primary coil 410. An alternating magnetic field is generated to induce a current into secondary coil 406A which transfers the surplus energy to the at least one low-energy cell 413A.

In one embodiment of the invention the transformer has a turns-ration of about ‘X’ to 1, wherein ‘X’ is the number of cells in the plurality of serially connected battery cells.

The method of the invention can be described with reference to the following.

The method is applied in a system of integrated battery charging and cell balancing comprising a plurality of serially connected cells 413 which together form a battery connected to a load 403. The system further comprises a transformer 401 having a primary coil 410 and a plurality of secondary coils 406. In the transformer the number of secondary coils 406 is equal to the number of cells 413. The system also comprises a plurality of switches 407 equal in number to the plurality of secondary coils 406 for connecting each cell of the plurality of serially connected cells to one of the plurality of secondary coils. There is also a capacitor 411 connected to the primary coil 410 by a second switch 408 and a battery charger 402 electrically connected to the plurality of serially connected cells 413 by a third switch 404. The system also includes a fourth switch 405 connecting the battery charger 402 to the primary coil 410. A system controller 415 controls the system.

The method is a method of charge control and comprises one of the following methods: initiating a system discharge mode, initiating a system discharge balancing mode, initiating a system bulk charging mode, initiating a system balanced charging mode and initiating a system fast charging mode.

The method of initiating a system discharge mode occurs when the load 403 (if present) is connected to the plurality of serially connected cells 413. The method of initiating a system discharge mode comprises the following steps initiated by the controller 415: opening the second switch 408; opening the third switch 404; opening the fourth switch 405; opening the plurality of first switches 407; so that only the load 403 is connected to said plurality of serially connected battery cells 413 for discharge.

In the method of initiating a discharge balancing mode the load 403 (if present) is connected to the plurality of serially connected cells 413. The plurality of serially connected cells 413 are electrically isolated from the plurality of secondary coils 406 by opening switches 407. At least one cell 413B has an energy surplus in an high-energy condition and at least one cell 413A has an energy deficit in an low-energy condition. Under these conditions, initiating the discharge balancing mode comprises the following steps initiated by the controller 415: 1 detecting the at least one high-energy cell 413B; 2 detecting the at least one low-energy cell 413A; 3 closing the first switch 407B connecting the at least one high-energy cell to its adjacent secondary coil 406B; 4 closing the second switch 408; 5 transferring the surplus of energy from the high-energy cell 413B through the adjacent secondary coil 406B into the primary coil 410 thereby generating a current flow into the second switch 408 and then into the capacitor 411 for energy storage; 6 determining the at least one low-energy cell 413A which needs to be balanced; 7 opening the closed first switch 407B; 8 opening the second switch 408; 9 closing the first switch 407A connecting the at least one low-energy cell 413A to its adjacent secondary coil 406A; 10 closing the second switch 408; 11 transferring the surplus of energy from the capacitor 411 through the primary coil 410 and into the secondary coil 406A adjacent to the low-energy cell 413A thereby generating a current flow into the closed first switch 407A adjacent to the low-energy cell and then into the low-energy cell; repeating steps 1 to 11 until all cells of the plurality of serially connected cells are energy balanced within a tolerance set by the controller.

The method initiating a bulk charging mode requires that the plurality of cells 413 be isolated from the plurality of secondary coils 406 by opening switches 407. The method of initiating the bulk charging mode comprises the following steps initiated by the controller: 1 closing the third switch 404 connecting the battery charger 402 to the plurality of serially connected cells 413; 2 the controller 415 detecting a full charge in the plurality of serially connected cells 413; and, 3 opening the third switch 404 to disconnect the battery charger 402 from the plurality of serially connected cells 413.

The method of initiating the balanced charging mode comprises the following steps initiated by the controller: 1 detecting the at least one low-energy cell 413A in the plurality of serially connected cells 413; 2 opening the plurality of first switches 407; 3 opening the second switch 408; 4 opening the third switch 404; 5 closing the fourth switch 405 to connect the battery charger 402 to the primary coil 410; 6 generating an alternating magnetic field within the primary coil; 7 generating a current in the secondary coil 406A adjacent to the low-energy cell 413A; 8 closing the first switch 407A adjacent connecting the low-energy cell 413A to the adjacent secondary coil 406A so that the current is transferred into the low-energy cell; 9 detecting a balanced condition in the low-energy cell; 10 opening the adjacent first switch 407A; 11 opening the fourth switch 405; and, 12 repeating steps 1 to 11 until the controller detects a balanced condition in the plurality of serially connected cells.

The method of initiating the fast charging mode comprises the steps of: 1 closing the third switch 404 to initiate the bulk charging mode; 2 simultaneously closing the fourth switch 405 to initiate the balanced charging mode; 3 maintaining the battery charger connected to the plurality of serially connected cells until the controller detects a full charge in the plurality of serially connected cells.

Although the description above contains much specificity, these should not be construed as limiting the scope of the invention but as merely providing illustrations of the presently preferred embodiment of this invention. Thus the scope of the invention should be determined by the appended claims and their legal equivalents.

### MODE FOR INVENTION

### INDUSTRIAL APPLICABILITY

Sequence List Text

1. A system 400 for integrated battery charging and cell balancing, said system comprising: a. a plurality of serially connected cells 413 forming a battery; b. a load 403 connected to said battery; c. a transformer 401 comprising a primary coil 410 and a plurality of secondary coils 406 wherein, the number of said plurality of secondary coils 406 is equal to the number of said plurality of serially connected cells 413 and wherein, each one of the plurality of secondary coils 406 is electrically connected to a single one of the plurality of serially connected cells 413 by one of a plurality of bi-directional first switches 407, said plurality of bi-directional first switches 407 equal in number to the plurality of the serially connected cells 413 and secondary coils 406; d. a capacitor 411 for energy storage connected to said primary coil 410 by a second switch 408; e. a battery charger 402 connected to the plurality of serially connected cells 413 by a third switch 404; f. a fourth switch 405 connecting said battery charger 402 to the primary coil 410; g. a controller 415 for controlling said system 400 on a bulk basis and on a cell-by-cell basis so that an energy surplus in the system is distributed in a balanced manner to and from one of said capacitor 411 and the plurality of serially connected cells 413.

2. The system of claim 1 wherein, the plurality of serially connected cells 413 forming said battery comprises at least one cell having an low-energy condition 413A and at least one cell having an high-energy condition 413B.

3. The system of claim 2 wherein, said controller 415 is adapted to identify said at least one cell having said low-energy condition 413A and said at least one cell having an high-energy condition 413B.

4. The system of claim 3 wherein, said second switch 408 is a balancing-charge switch element.

5. The system of claim 4 wherein, said balancing-charge switch 408 is a synchronous rectifier to deliver said energy surplus from one of said battery charger 402 and/or said plurality of cells 413 into the primary coil 410 and then into said capacitor 411 for energy storage.

6. The system of claim 5 wherein, capacitor 411 has the energy surplus and wherein, said third switch 404 may be open or closed depending on the speed of charge desired and said fourth switch 405 is open, said plurality of first switches 407 are closed and the balancing-charge switch 408 is closed and wherein, the balancing charging switch 408 is a first waveform generator for generating an alternating magnetic field in the primary coil 410 using the energy surplus thereby generating a current in the plurality of secondary coils 406 hence charging and balancing the plurality of serially connected cells 413 through the plurality of first switches 407 until a charged and balanced condition is detected by said controller.

7. The system of claim 5 wherein, the capacitor 411 has the energy surplus and wherein, the controller 415 detects at least one cell 413A being low-energy and wherein, the third switch 404 is open or closed depending on weather the battery is charging or not, and the fourth switch 405 is open and wherein, the balancing-charge switch 408 is closed and wherein, first switch 407A is closed so that the surplus energy is transferred from the capacitor to the primary coil 410 generating an alternating magnetic field and thus a current into the adjacent secondary coil 406A and then into the at least one cell 413A to increase the energy level of the low-energy cell.

8. The system of claim 1 wherein, the fourth switch 405 is open and second switch 408 is open and the plurality of first switches 407 are open and wherein, the third switch 404 is a bulk charge control switch so that when said bulk charge control switch is closed said battery charger 402 simultaneously charges all cells in the plurality of serially connected cells 413.

9. The system of claim 1 wherein, the fourth switch 405 is a second waveform generator for generating the alternating magnetic field in the primary coil 410, so that when said second waveform generator 405 is closed, second switch 408 is open and surplus energy is transferred from the battery charger 402 through the second waveform generator 405 to the primary coil 410 thereby generating the alternating magnetic field and hence a current in the plurality of secondary coils 406 for charging and balancing the plurality of serially connected cells 413 through closed first switches 407.

10. The system of claim 3 comprising the at least one high-energy cell 413B having the energy surplus, the at least one low-energy cell 413A having an energy deficit, the second switch 408 in an open position, the third switch 404 in an open position, the fourth switch 405 in an open position and switches 407 in open positions wherein, the controller closes the first switch 407B adjacent to the at least one high-energy cell 413B and closes the first switch 407A adjacent to the at least one low-energy cell 413A so that the energy surplus is transferred from cell 413B through secondary coil 406A to the primary coil 410 wherein the alternating magnetic field is generated to induce a current into secondary coil 406A which transfers the surplus energy to the at least one low-energy cell 413A.

11. The system of claim 1 wherein, the transformer has a turns-ration of about ‘X’ to 1, wherein ‘X’ is the number of cells in the plurality of serially connected battery cells.

12. In a system of integrated battery charging and cell balancing comprising:
a. a plurality of serially connected cells 413 which together form a battery connected to a load 403;
b. a transformer 401 having a primary coil 410 and a plurality of secondary coils 406, wherein the number of said plurality of secondary coils 406 is equal to the number of said plurality of cells 413;
c. a plurality of first switches 407 equal in number to the plurality of secondary coils 406 for connecting each cell of the plurality of serially connected cells to one of said plurality of secondary coils;
d. a capacitor 411 connected to said primary coil 410 by a second switch 408;
e. a battery charger 402 electrically connected to the plurality of serially connected cells 413 by a third switch 404;
f. a fourth switch 405 connecting said battery charger 402 to the primary coil 410; and,
g. a system controller 415;
h. a method of charge control comprising one of the following methods:
i. initiating a system discharge mode;
ii. initiating a system discharge balancing mode;
iii. initiating a system bulk charging mode;
iv. initiating a system balanced charging mode; and,
initiating a system fast charging mode.

13. The method of claim 12 wherein, the load 403 (if present) is connected to the plurality of serially connected cells 413, said method of initiating said discharge mode comprises the following steps initiated by said controller 415:
a. opening said second switch 408;
b. opening said third switch 404;
c. opening said fourth switch 405;
d. opening said plurality of first switches 407;
so that only the load 403 is connected to the plurality of serially connected battery cells 413 for discharge.

14. The method of claim 12 wherein, the load 403 (if present) is connected to the plurality of serially connected cells 413 and wherein, the plurality of serially connected cells 413 are electrically isolated from the plurality of secondary coils 406 and comprise at least one cell 413B having an energy surplus in an high-energy condition and at least one cell 413A having an energy deficit in an low-energy condition, said method of initiating a discharge balancing mode comprising the following steps initiated by the controller 415:
a. detecting the at least one high-energy cell 413B;
b. detecting the at least one low-energy cell 413A;
c. closing the first switch 407B connecting the at least one high-energy cell to its adjacent secondary coil 406B;
d. closing the second switch 408;
e. transferring said surplus of energy from the high-energy cell 413B through the adjacent secondary coil 406B into the primary coil 410 thereby generating a current flow into the second switch 408 and then into the capacitor 411 for energy storage;
f. determining the at least one low-energy cell 413A which needs to be balanced;
g. opening the closed first switch 407B;
h. opening the second switch 408;
i. closing the first switch 407A connecting the at least one low-energy cell 413A to its adjacent secondary coil 406A;
j. closing the second switch 408;
k. transferring said surplus of energy from the capacitor 411 through the primary coil 410 and into the secondary coil 406A adjacent to the low-energy cell 413A thereby generating a current flow into the closed first switch 407A adjacent to the low-energy cell and then into the low-energy cell;
repeating steps a to k until all cells of the plurality of serially connected cells are energy balanced within a tolerance set by the controller.

15. The method of claim 12 wherein, the plurality of cells 413 are isolated from the plurality of secondary coils 406 and wherein, the method of initiating said bulk charging mode comprises the following steps initiated by the controller:
a. closing the third switch 404 connecting the battery charger 402 to the plurality of serially connected cells 413;
b. the controller 415 detecting a full charge in the plurality of serially connected cells 413; and,
c. opening the third switch 404 to disconnect the battery charger 402 from the plurality of serially connected cells 413.

16. The method of claim 12 wherein, the method of initiating said balanced charging mode comprises the following steps initiated by the controller:
a. detecting the at least one low-energy cell 413A in the plurality of serially connected cells 413;
b. opening the plurality of first switches 407;
c. opening the second switch 408;
d. opening the third switch 404;
e. closing the fourth switch 405 to connect the battery charger 402 to the primary coil 410;
f. generating an alternating magnetic field within the primary coil;
g. generating a current in the secondary coil 406A adjacent to the low-energy cell 413A;
h. closing the first switch 407A adjacent connecting the low-energy cell 413A to the adjacent secondary coil 406A so that said current is transferred into the low-energy cell;
i. detecting a balanced condition in the low-energy cell;
j. opening the adjacent first switch 407A;
k. opening the fourth switch 405; and,
l. repeating steps a to k until the controller detects a balanced condition in the plurality of serially connected cells.

17. The method of claim 12 wherein, the method of initiating said fast charging mode comprises the steps of:
a. closing the third switch 404 to initiate the bulk charging mode;
b. simultaneously closing the fourth switch 405 to initiate the balanced charging mode;
c. maintaining the battery charger connected to the plurality of serially connected cells until the controller detects a full charge in the plurality of serially connected cells.
